(19) United States
(12) Patent Application Publication
(10) Pub. No.: US 2016/0143015 A1
(43) Pub. Date: May 19, 2016

(54) CELL OPERATION CONCEPT

(71) Applicant: NOKIA SOLUTIONS AND NETWORKS OY, Espoo (FI)

(72) Inventors: Patrick MARSCH, Wroclaw (PL); Frank FREDERICKSEN, Klarup (DK)

(21) Appl. No.: 14/898,663

(22) PCT Filed: Jun. 17, 2013
(86) PCT No.: PCT/EP2013/062492

§ 371 Date: Dec. 15, 2015

(51) Int. Cl. H04W 72/04; H04L 5/00; H04W 72/14

(52) U.S. Cl. CPC H04W 72/0406; H04W 72/14; H04L 5/0055; H04L 5/0048

(57) ABSTRACT

It is provided a method, including: exchanging first data with a data transceiver device using a data resource; exchanging one or more data control messages with the data transceiver device using a control resource different from the data resource, wherein each of the one or more data control messages is directly related to the exchanging of the first data; exchanging one or more first control messages with a control transceiver device different from the data transceiver device using the control resource, wherein each of the one or more first control messages is not directly related to the exchanging of the first data.

### FIELD

The present invention relates to an apparatus, a method, a system, and a computer program product related to mobile communication networks. More particularly, the present invention relates to an apparatus, a method, a system, and a computer program product embodying a concept of signaling and cell operation.

### BACKGROUND

### ABBREVIATIONS

3G 3^{rd} Generation
3GPP 3^{rd} Generation Partnership Project
4G 4^{th} Generation
5G 5^{th} Generation
ACK Acknowledged
BTS Base Transceiver Station
CQI Channel Quality Indicator
D2D Device to Device Communication
DL Downlink
eNB Evolved Node B
ICIC Intercell Interference Cancelation
LTE™ Long Term Evolution
LTE-A™ Long Term Evolution-Advanced
MIMO Multiple Input Multiple Output
NACK Not Acknowledged
OTA Over the Air
RAN Radio Access Network
RRH Remote Radio Head
RRM Radio Resource Management
UE User Equipment
UL Uplink
UMTS Universal Mobile Telecommunication System
UTRAN UMTS Radio Access Network
WCDMA Wideband Code Division Multiplex Access
WiFi™ Wireless Fidelity

First simulation results have indicated that there is a large benefit of centralized radio resource management and centralized link adaptation in dense network deployments that will be likely deployed in the future. However, it is also clear that in dense deployments, the cost per access point has to be reduced, which is to an extent driven by the latency requirements of the backhaul infrastructure.

Centralized radio resource management is particularly beneficial if the system is supposed to exploit a flexible usage of transmit resources for uplink and downlink in different cells, and when direct device-to-device transmission among adjacent cells is to be supported. Solutions currently foreseen would be to use a centralized RAN architecture, i.e. to perform signal processing at a central network entity to which many cells are connected in the form of remote radio heads (RRHs). Another approach is to perform control plane signalling via macro cells and provide the user plane via small cells, but in this case it is so far also foreseen to have the small cells implemented in the form of RRHs. In both cases, the backhaul/fronthaul infrastructure involved in operating the small cells is typically expensive.

Embodiments relate to how the same or a similar radio resource management performance can be obtained as in e.g. a centralized RAN, but without requiring expensive backhaul or fronthaul infrastructure.

WO 2011/134531 (“Carrier management in heterogeneous network environments”) discloses signalling from a macro cell to a small cell which indicates to the small cell that certain carriers are not to be used for scheduling.

### SUMMARY

It is an object of the present invention to improve the prior art.

According to a first aspect of the invention, there is provided an apparatus, comprising at least one processor and at least one memory including a computer program code, the at least one memory and the computer program code configured to, with the at least one processor, cause the apparatus at least to: exchanging first data with a data transceiver device using a data resource; exchanging one or more data control messages with the data transceiver device using a control resource different from the data resource, wherein each of the one or more data control messages is directly related to the exchanging of the first data; exchanging one or more first control messages with a control transceiver device different from the data transceiver device using the control resource, wherein each of the one or more first control messages is not directly related to the exchanging of the first data.

According to a second aspect of the invention, there is provided an apparatus, comprising at least one processor and at least one memory including a computer program code, the at least one memory and the computer program code configured to, with the at least one processor, cause the apparatus at least to: overhearing one or more first control messages on a control resource from a control transceiver device; exchanging data with a terminal device using a data resource based on the first control messages, wherein the terminal device is different from the control receiver device, and the control resource is different from the data resource.

According to a third aspect of the invention, there is provided an apparatus, comprising at least one processor and at least one memory including a computer program code, the at least one memory and the computer program code configured to, with the at least one processor, cause the apparatus at least to: receiving, on a control resource, one or more assigning messages from a control transceiver device; assigning a portion of a data resource different from the control resource to the exchanging of data with a terminal device different from the control transceiver device based on the received one or more assigning messages.

According to a fourth aspect of the invention, there is provided an apparatus, comprising at least one processor and at least one memory including a computer program code, the at least one memory and the computer program code configured to, with the at least one processor, cause the apparatus at least to: exchanging one or more first control messages with a terminal device using a control resource, wherein each of the one or more first control messages is not directly related to an exchanging of first data between the terminal device and a transceiver device different from the apparatus using a data resource different from the control resource; receiving, from at least one of the terminal device and a transceiver device different from the terminal device, an information related to the exchanging of the first data by the terminal device, wherein the exchanging is based on the one or more first control messages; and adapting, based on the received information, one or more of the future first control messages.

According to a fifth aspect of the invention, there is provided an apparatus, comprising at least one processor and at least one memory including a computer program code, the at least one memory and the computer program code configured to, with the at least one processor, cause the apparatus at least to: providing, on a control resource, one or more assigning messages to a transceiver device, wherein each of the one or more assigning messages is adapted to assign a portion of a data resource different from the control resource to a data exchange between a terminal device and the transceiver device.

According to a sixth aspect of the invention, there is provided a method, comprising:
exchanging first data with a data transceiver device using a data resource; exchanging one or more data control messages with the data transceiver device using a control resource different from the data resource, wherein each of the one or more data control messages is directly related to the exchanging of the first data; exchanging one or more first control messages with a control transceiver device different from the data transceiver device using the control resource, wherein each of the one or more first control messages is not directly related to the exchanging of the first data.

According to a seventh aspect of the invention, there is provided a method, comprising: overhearing one or more first control messages on a control resource from a control transceiver device; exchanging data with a terminal device using a data resource based on the first control messages, wherein the terminal device is different from the control receiver device, and the control resource is different from the data resource.

According to an eighth aspect of the invention, there is provided a method, comprising: receiving, on a control resource, one or more assigning messages from a control transceiver device; assigning a portion of a data resource different from the control resource to the exchanging of data with a terminal device different from the control transceiver device based on the received one or more assigning messages.

According to a ninth aspect of the invention, there is provided a method, comprising: exchanging one or more first control messages with a terminal device using a control resource, wherein each of the one or more first control messages is not directly related to an exchanging of first data between the terminal device and a transceiver device different from an apparatus performing the method using a data resource different from the control resource; receiving, from at least one of the terminal device and a transceiver device different from the terminal device, an information related to the exchanging of the first data by the terminal device, wherein the exchanging is based on the one or more first control messages; and adapting, based on the received information, one or more of the future first control messages.

According to a tenth aspect of the invention, there is provided a method, comprising: providing, on a control resource, one or more assigning messages to a transceiver device, wherein each of the one or more assigning messages is adapted to assign a portion of a data resource different from the control resource to a data exchange between a terminal device and the transceiver device.

Each of the methods of the sixth to tenth aspects may be a method of cell operation.

According to an eleventh aspect of the invention, there is provided a computer program product comprising a set of instructions which, when executed on an apparatus, is configured to cause the apparatus to carry out the method according to any one of the sixth to tenth aspects. The computer program product may be embodied as a computer-readable medium.

According to some embodiments of the invention, at least one of the following advantages may be achieved:
centralized radio resource management can be realized, e.g. in 5G systems;
small cell backhaul latency requirements are relaxed;
performance of the centralized radio resource management is at least comparable to the prior art;
infrastructure costs are reduced;
signalling delay is reduced;
less handovers with corresponding control message exchange are required;
fine control of radio resources is enabled;
no modifications are required on the UE; i.e. some embodiments of the solution are fully backward compatible to the UE;
may be applied to UEs with a single frequency receiver;
transmit power on UE may be reduced;
interference may be reduced.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of some embodiments which is to be taken in conjunction with the appended drawings, wherein

FIG. 1 shows an exemplifying configuration of a macro cell and small access points with some terminals;

FIG. 2 sketches the usage of the control and data frequency bands according to a first variant according to embodiments of the invention;

FIG. 3 sketches the usage of the control and data frequency bands according to a second variant according to embodiments of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention;

FIG. 10 shows an apparatus according to an embodiment of the invention;

FIG. 11 shows a method according to an embodiment of the invention;

FIG. 12 shows an apparatus according to an embodiment of the invention;

FIG. 13 shows a method according to an embodiment of the invention;

FIG. 14 shows a message flow according to an embodiment of the invention;

FIG. 15 shows a message flow according to an embodiment of the invention; and

FIG. 16 shows an apparatus according to an embodiment of the invention.

### DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

It should be appreciated that communication systems and apparatuses thereof will be integrated towards an infrastructure (more and more) based on undedicated and programmable hardware providing needed functionalities. A network element may be a computing equivalent device that gathers programmable resources based on virtualization technologies. In addition, at least some functionalities may be carried out by using cloud services.

Moreover, it is to be understood that the apparatus is configured to perform the corresponding method, although in some cases only the apparatus or only the method are described.

According to some embodiments of the invention, centralized radio resource management can be realized in 3GPP networks such as 3G, 4G, or 5G systems or beyond (or in other systems comprising corresponding architecture and/or functionalities) while at the same time relaxing small cell backhaul latency requirements through using a (partial) split of control plane and user plane functionality and signalling in conjunction with a particular framework of over-the-air (OTA) signalling between all communicating entities.

According to some embodiments of the invention, a (partial) control plane/user plane split is used in conjunction with a particular framework of over-the-air-signalling to enable centralized radio resource management under relatively low infrastructure cost.

According to some embodiments of the invention, a multi-layer/multi-cell signalling structure is created, wherein one layer is dominant over the other in terms of control of physical resources. According to this concept, the dominant layer transmits and receives information relevant to the control of physical resources for the entire coverage area, while cells at the non-dominant layer may or may not have further control of actions on physical resources within the respective local areas of the smaller cells.

Some embodiments of the invention provide centralized or close-to-centralized radio resource management without requiring small cell access points to be connected to some sophisticated infrastructure. As all delay-critical signalling between macros and small cell access points and terminals is handled over the air, small cells may be connected to the Internet through a cheap (possibly third party) internet connection over which only user data has to be transmitted.

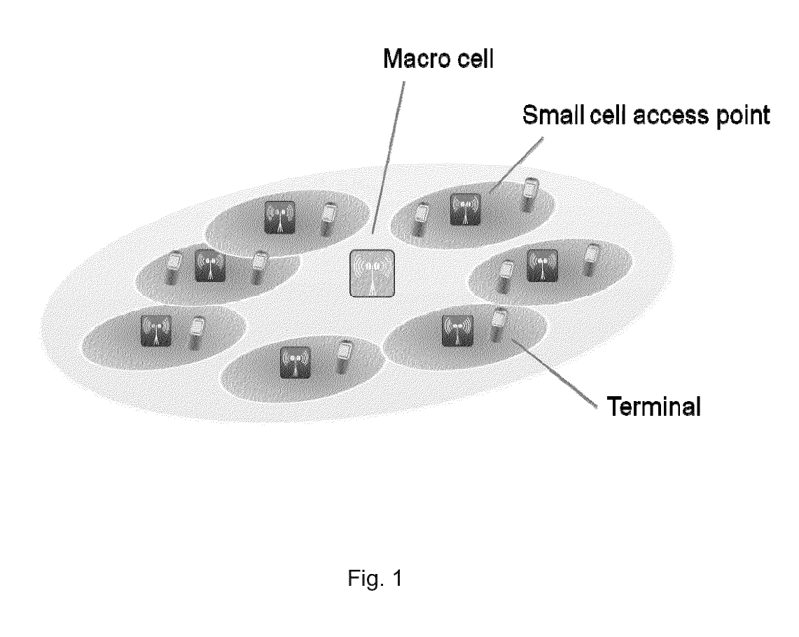

FIG. 1 shows an exemplifying deployment on which embodiments of the inventions may be applied. The deployment comprises cells covering a larger geographical area (in the sequel denoted as macro cells), and more than one small cell access points (in the sequel denoted as small cells). The small cells may be realized as RRHs. In addition, terminals are depicted in FIG. 1 which are in the coverage area of both the macro cell and one of the small cells.

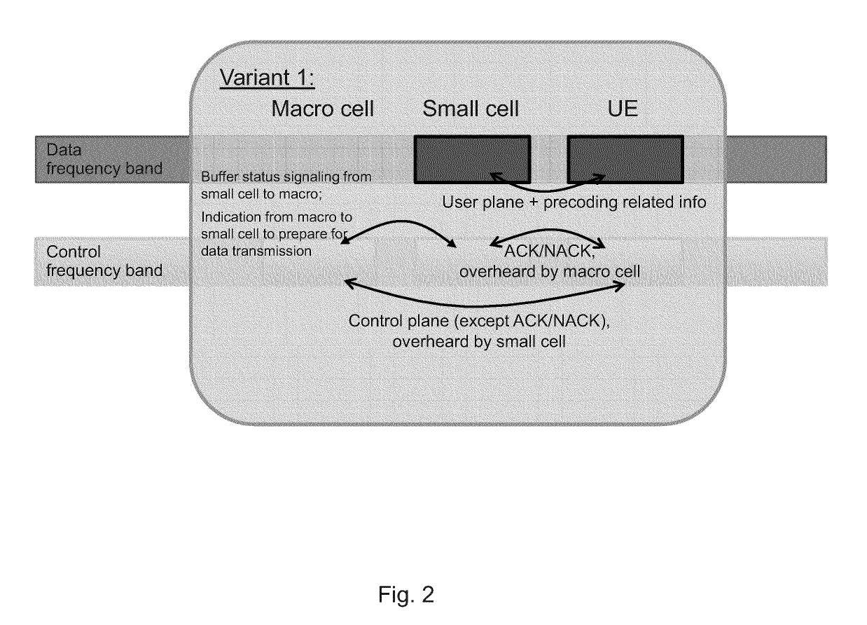

According to embodiments of the invention, macro cells are able to transmit and receive at least on one frequency band (in the sequel denoted as control frequency band, shown in FIG. 2 at the bottom), and the small cell access points are able to transmit and receive on the control frequency band as well as on a data frequency band different from the control frequency band (shown as higher frequency band in FIG. 2). Terminals are able to transmit and receive on both frequency bands or only on the data frequency band, depending on the invention variant below.

Note that the invention is not limited to a particular usage of frequency bands. I.e., the carrier frequency of the control frequency band may be higher or lower than the carrier frequency of the data frequency band, there could be two or more control frequency bands, two or more data frequency bands. In some embodiments, there is one “meta”-frequency band which comprises both the control frequency band and the data frequency band. For example, the meta-frequency band may comprise 100 MHz, whereof 10 to 50 MHz may be used as control frequency band and the remaining 50 to 90 MHz may be used as data frequency band.

We consider the following two variants (in the sequel described for one macro cell and the many small cells and terminals under its coverage). However, it should be appreciated that these variants are only taken herein as examples:

### Variant 1: Complete Control by Macro Cell, Small Cells Transparent to Devices (Shown in FIG. 2)

a. All control plane functionality and signalling is handled via the macro cell and through the control frequency band unless stated in the sequel. Small cells overhear the control plane signalling.
It may be provided that the macro cell, all terminals and small cells under the coverage of this macro cell can reliably receive any signalling on the control frequency band. For this reason, in some embodiments a particularly robust coding (e.g. potentially lower code rates than in e.g. Long Term Evolution Advanced (LTE-A)) may be used on the control frequency band. In some embodiments, a flexible code rate for this signalling is used which is dynamically adjusted according to the communication scenario (e.g. indoor/outdoor), such that all communication entities can reliably decode signalling.

b. ACK/NACK signalling and potentially feedback on small scale channel information (e.g. any precoding-related information, channel quality indicators etc.) are handled between those entities involved in actual data transmissions (i.e. between a small cell and a terminal or between two terminals in the case of D2D) through the control frequency band;
In some embodiments, at least a part of this signalling is overheard by the macro cell. Namely, in some of these embodiments, information relevant for scheduling, such as ACK/NACK signalling, CQIs, MIMO rank selection and rank preferences, HARQ control messages, choice of transmit formats, and modulation and coding schemes is overheard by the macro cell. In these embodiments, at least the overheard part of the signalling is preferably transmitted in a robust way, i.e. potentially with a code rate adjusted to the scenario outlined under point a. hereinabove. On the other hand, in some embodiments, signalling directly related to an ongoing data transmission, such as a selection of precoding matrices, is not overheard by the macro cell. It may be exchanged between the small cell and UE in the control frequency band or in the data frequency band depending on the specific embodiment, in whole or in some aggregated form.
In some embodiments, the macro cell does not overhear the signalling between the terminal and the small cell. In these embodiments, the macro cell may receive information which it may use for instance to make scheduling decisions (i.e. information comprised in or derivable from the signalling between UE and small cell which is, according to the other embodiments described hereinabove, preferably overheard by the macro) from the small cell. The small cell may provide this information to the macro cell directly over the air or over some wireless or wireline backhaul, possibly involving another node in between. The small cell may aggregate the corresponding information from the UE and provide only some aggregated information (e.g. an averaged CQI) to the macro.
In these embodiments, the macro cell may receive the relevant information from the UE with some delay and potentially with a lower granularity. However, on the other hand, the UE may transmit with a lower power because the UE's signalling is not overheard by the macro. Thus, interference may be reduced, too.
Table 1 indicates which signalling is exchanged between macro cell and UE on the control frequency band. In different embodiments, at least one of these signallings is exchanged between macro cell and UE on the control frequency band. This signalling may be identified as not directly related to exchanging data or indirectly related to exchanging data.
Table 1 also shows which signalling is exchanged between small cell and UE.

According to different embodiments, at least one of these signallings is exchanged between the small cell and the UE on either of the data frequency band or the control frequency band. This signalling may be identified as directly related to the exchanging of data between small cell and UE. More precisely, it may also be identified as directly related to the exchanging of data after a grant for the exchanging of data has been issued. According to some embodiments, some of the signalling directly related to the exchanging of data may be overheard by the macro cell (marked as “possibly” in table 1). However, according to different embodiments, none, some, or all of the signalling indicated as “possibly” in Table 1 is overheard by the macro.

TABLE 1
assignment of signallings to involved nodes and frequency bands

| | | | Small | | UE→small | |
|---|---|---|---|---|---|---|
| | Macro→small cell | Macro→UE | cell→UE | Small cell→macro | cell | UE→macro |
| Scheduling | Scheduling grants | | | | | |
| grants | (Control frequency band) | | | | | |
| ACK/NACK after UL tx | | | ACK/NACK | Possibly: | | |
| | | | for previous | ACK/NACK for | | |
| | | | UE UL data | previous UE UL | | |
| | | | transmission | data | | |
| | | | (data | transmission or | | |
| | | | frequency | aggregated form | | |
| | | | band or | thereof | | |
| | | | control | (control | | |
| | | | frequency | frequency band | | |
| | | | band | or any other | | |
| | | | preferably if | wireline/wireless | | |
| | | | to be | form) | | |
| | | | overheard by | | | |
| | | | macro) | | | |
| ACK/NACK | | | | Possibly: | ACK/NACK | Possibly: |
| after DL tx | | | | Aggregated form | for previous | ACK/NACK |
| | | | | of ACK/NACK | small cell DL | for previous |
| | | | | information from | data | small cell DL |
| | | | | UE | transmission | data |
| | | | | (control | (data | transmission |
| | | | | frequency band | frequency | (data |
| | | | | or any other | band, or | frequency |
| | | | | wireline/wireless | control | band or |
| | | | | form | frequency | control |
| | | | | | band | frequency |
| | | | | | preferably if | band) |
| | | | | | to be | |
| | | | | | overheard by | |
| | | | | | macro) | |
| CQI/rank selection | | | | Possibly: | Channel | Possibly: |
| | | | | Aggregated/ | quality | Channel |
| | | | | compressed form | indicator | quality |
| | | | | of channel | (CQI) and | indicator |
| | | | | quality (CQI) and | rank | (CQI) and |
| | | | | rank selection | selection | rank |
| | | | | (RI) feedback | (RI) | selection |
| | | | | from UE | feedback | (RI) |
| | | | | (control | (data | feedback |
| | | | | frequency band | frequency | (data |
| | | | | or any other | band, or | frequency |
| | | | | wireline/wireless | control | band or |
| | | | | form) | frequency | control |
| | | | | | band | frequency |
| | | | | | preferably if | band) |
| | | | | | to be | |
| | | | | | overheard by | |
| | | | | | macro) | |
| Precoding | | | | | Feedback | |
| related | | | | | signaling | |
| | | | | | related to | |
| | | | | | precoding | |
| | | | | | (data | |
| | | | | | frequency | |
| | | | | | band) | |
| Power control | | Power | Power | | | |
| | | control | control | | | |
| | | commands | commands | | | |
| | | for UE | for UE | | | |
| | | transmission | transmission | | | |
| | | power on | power on | | | |
| | | control | data | | | |
| | | frequency | frequency | | | |
| | | band | band | | | |
| | | (Control | (data | | | |
| | | frequency | frequency | | | |
| | | band) | band) | | | |
| Special control | Indication to a | | | Buffer status and | | |
| | small cell that | | | packet urgency | | |
| | this should | | | information | | |
| | prepare to | | | (Control | | |
| | transmit to or | | | frequency band) | | |
| | receive from a | | | | | |
| | UE in the future | | | | | |
| | (Control | | | | | |
| | frequency band | | | | | |
| | or other | | | | | |
| | wireline/wireless | | | | | |
| | form) | | | | | |
| Data transmission | | | Downlink | | Uplink | |
| | | | demodulation | | demodulation | |
| | | | reference | | reference | |
| | | | symbol and | | symbol and | |
| | | | data | | data | |
| | | | transmission | | transmission | |
| | | | (data | | (data | |
| | | | frequency | | frequency | |
| | | | band) | | band) | |
| Other | | Any other | | | | Any other |
| signaling | | DL control | | | | UL control |
| | | signaling | | | | signaling |
| | | (Control | | | | (Control |
| | | frequency | | | | frequency |
| | | band) | | | | band) |

In the context of the present application, “overhearing a signalling” may or may not include “demodulating and/or decoding the signalling”. For example, a scheduling grant provided by the macro to the UE will be decoded by the small cell in order to successfully exchange data. On the other hand, according to some embodiments, an ACK exchanged between UE and small cell is not decoded by the macro cell overhearing it because it is not of relevance for the scheduling.

c. All data transmission is handled between communicating entities (i.e. between a small cell and a terminal or between two terminals in the case of D2D) through the data frequency band;
In some embodiments, e.g. for a latency-critical application, a terminal may also receive data transmissions directly from the macro cell via any frequency band including e.g. the control frequency band;

d. Small cells may forward buffer status and/or packet delay information to the macro cell via the control frequency band;
This information which is signalled over the air to the macro cell may consist of
i) general information on buffer statuses and the urgency of particular data to be transmitted from or to terminals or between two terminals, and
ii) signalling which provides incremental information to that previously provided.
For example, a small cell access point may signal to the macro cell that it has urgent data waiting for one of its currently served terminals which needs (more) radio resources very soon.

e. Scheduling grants sent by the macro cell to the terminal are overheard by all small cells under the macro coverage. The grants may contain information on which small cell(s) are to transmit data or receive data from the terminal.

f. The macro cell may use signalling over the control frequency band to a small cell to indicate that this small cell should prepare to transmit to a terminal in the future, for instance by starting to load transmit buffers.
Depending on the core network architecture and the connectivity between small cell access points and the core network, the macro cell may also initiate that user plane data is provided to the small cell via the backhaul infrastructure;
In some embodiments of the invention, some downlink grants transmitted from a macro cell to a terminal also contain information about which data is to be transmitted by the small cell (e.g. which part of the data the small cell has in its data buffer).

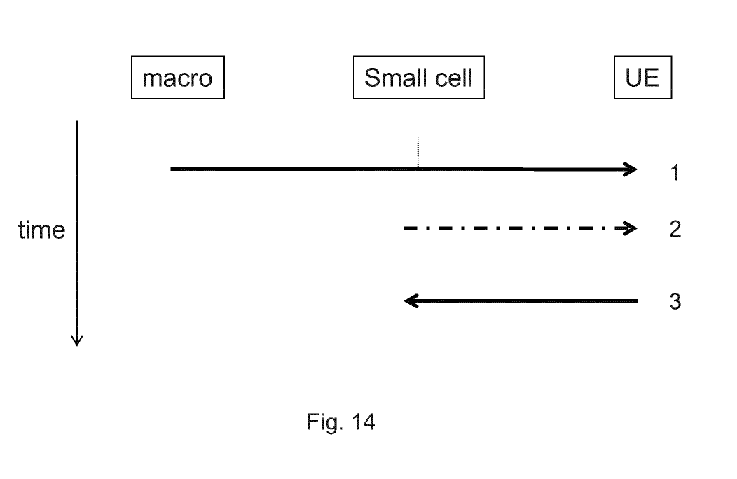

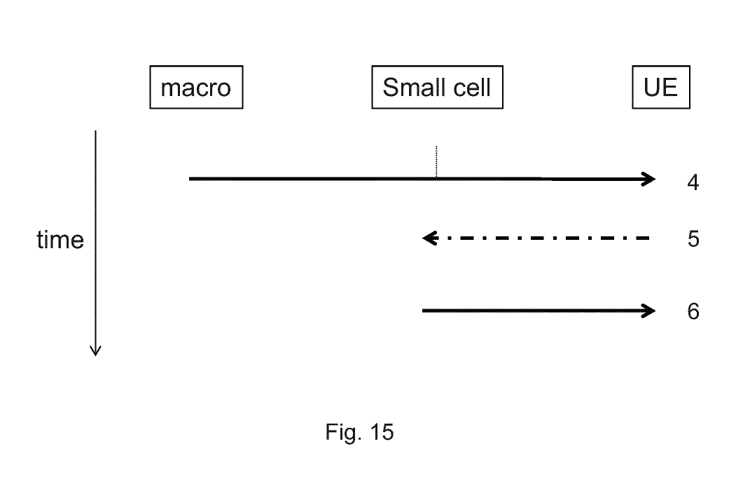

Examplary message flows are shown in FIGS. 14 and 15, wherein only some message of particular relevance are shown.

By message 1 of FIG. 14, the macro cell sends a downlink grant to the UE on the control frequency band (continuous line). This message is overheard by the small cell (thin dotted line) which then derives from this information that it has to perform a data transmission in the next transmit interval to this UE. Message 2 indicates data transmission from the small cell to UE on the data frequency band (dash-dotted line). By message 3, UE sends ACK/NACK to the data transmission on the control frequency band.

By message 4 of FIG. 15, the macro cell sends an uplink grant to the UE on the control frequency band (continuous line). This message is overheard by the small cell (thin dotted line) which then derives from this information that it has to expect a reception of a data transmission in the next transmit interval from this UE. Message 5 indicates data transmission from the UE to the small cell on the data frequency band (dash-dotted line). By message 6, small cell sends ACK/NACK to the data transmission on the control frequency band.

In FIGS. 14 and 15, message flows are shown where the macro cell does not overhear the ACK/NACK signalings 3 and 6, respectively. In some embodiments, the macro cell may overhear one or both of these ACK/NACk signallings.

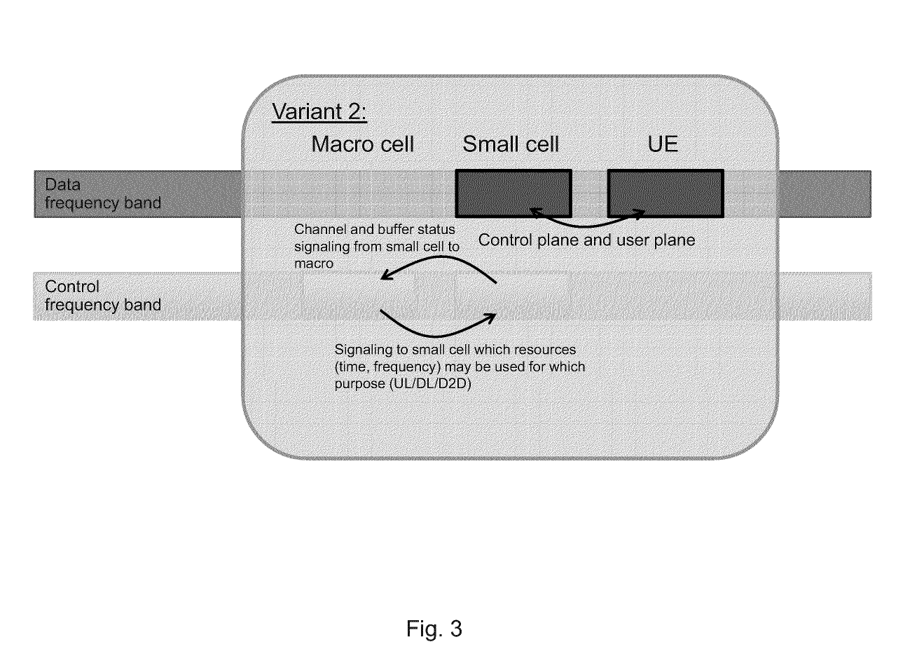

### Variant 2: Control Split Between Macro Cell and Small Cells, Small Cells Visible to Devices (Shown in FIG. 3)

a. The macro cell sends information to the small cell access points through the control frequency band to indicate which subset of resources in the data frequency band (e.g. in time and frequency) the different small cell access points may schedule to a subset of terminals. This information may also contain information on whether small cell access points may schedule resources for particular kinds of transmission (i.e. uplink, downlink, direct D2D);
This signalling may contain the information that certain resources (e.g. in time and frequency) may only be scheduled to certain terminals (as for instance as these transmissions will hardly generate interference to other cells);
This signalling may contain information that certain resources (e.g. in time and/or frequency) may only be scheduled to terminals with certain link properties (e.g. in a certain proximity to the small cell);
This signalling may contain the information that certain resources may only be used for uplink or downlink transmission or direct D2D transmission between certain entities;
This signalling may contain the information that certain resources may only be used in a particular repetitive pattern (as an example: the macro may define repetitive resources blocks that can be used for uplink transmission only, or for the scheduling of a certain subset of terminals only);
This signalling may contain both positive and negative information (e.g. it may instruct a small cell which resources can be used, and/or it may instruct a small cell which resources may not be used, meaning that all other resources would be useable);
This signalling may contain information indicating whether any scheduling possibilities or constraints are to be interpreted as additional or subtractive to previously defined constraints (i.e. whether the receiving small cell access point should treat consecutively received information with a logical OR or logical AND).

b. The control plane and user plane functionality and signalling is handled as in classical systems between the small cells and their assigned terminals (or between two devices in the case of direct D2D) over the data frequency band, but the scheduling is constrained according to the information received from the macro cell before;

c. The small cells may provide information (e.g. channel information, buffer status information etc.) via the lower frequency band to the macro cell, which the latter may need to make centralized radio resource management decisions.
In some embodiments, the macro signals to the small cells via the control frequency band details of channel and/or buffer status information (e.g. which subset of links, which granularity, frequency of reporting etc.) it desires from the small cells

In some embodiments, combinations of variants 1) and 2) above are employed. In these embodiments, some small cells are visible to terminals and perform part of the control signalling, while others are transparent to the terminals.

Both variants 1) and 2) could be combined with any existing coordination scheme between multiple macro cells (e.g. ICIC etc.).

Variant 1 may be better suited to situations where the following aspects are beneficial:
Less signalling delay is involved than according to variant 2, as e.g. terminals directly receive scheduling grants from the assigned macro cell. However, the delay is still a bit larger than in classical systems: If a downlink grant is sent by the macro, the transmission by the small cell can only take place in the next transmit interval; and
As long as a terminal is moving within the coverage of one macro, no hand-over etc. is needed, as the small cells are transparent to the terminal, in other words, fewer handovers may take place.

Variant 2 may be better suited to situations, where the following aspects are beneficial:
Terminals need only operate on the data frequency band; and
Terminals need only use a strongly reduced transmit power, as they need to communicate only with a nearby small cell access point and not the macro cell

Both variants 1) and 2) could also be used if only one frequency band is available. In this case, the single frequency band may be split into two portions, i.e. the control frequency band and the data frequency band. These portions should preferably not overlap. The portions may be dynamically adjusted by the macro cell, e.g. depending on the number of small cells to be controlled by one macro cell or based on some traffic pattern such as the number of control messages to be sent or the channel and/or buffer status of one or more of the small cells.

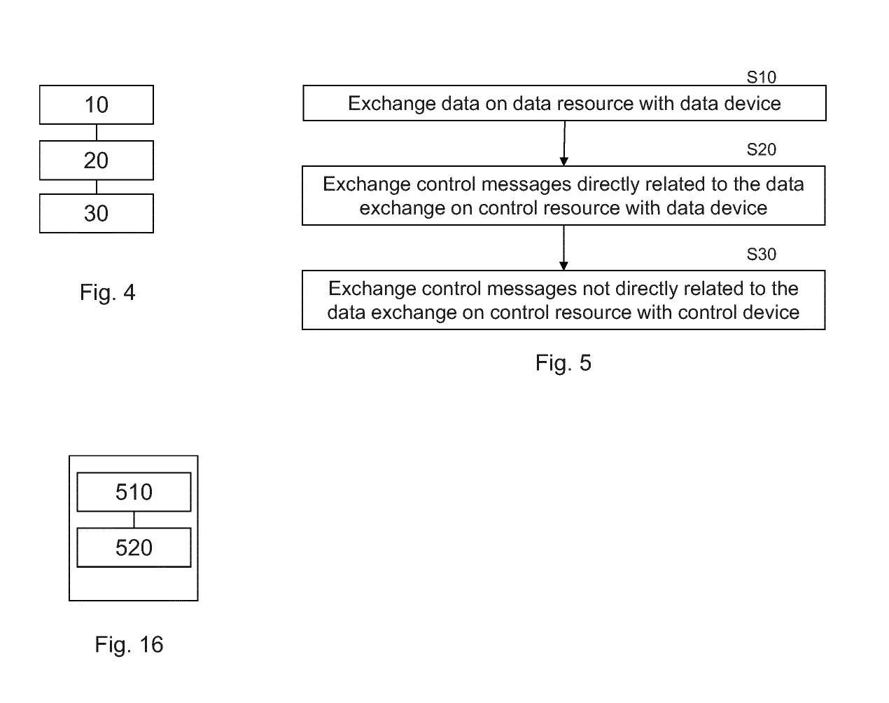

FIG. 4 shows an apparatus according to an embodiment of the invention. The apparatus may be a terminal or user device such as a UE, or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises data exchanging means 10, data control exchanging means 20, and first control exchanging means 30.

The data exchanging means 10 exchanges data with a data (transceiver) device such as a base station or a RRH using a data resource (S10). The data may be related to the user plane.

The data control exchanging means 20 exchanges one or more data control messages with the data (transceiver) device (S20). It uses a control resource different from the data resource. Each of the one or more data control messages is directly related to the exchanging of the data by the data exchanging means 10.

The first control exchanging means 30 exchanges one or more first control messages with a control (transceiver) device different from the data (transceiver) device (S30). The control (transceiver) device may be a base station such as a macro BTS. The first control exchanging means 30 uses the control resource. Each of the one or more first control messages is not directly related to the exchanging of the data by the data exchanging means 10.

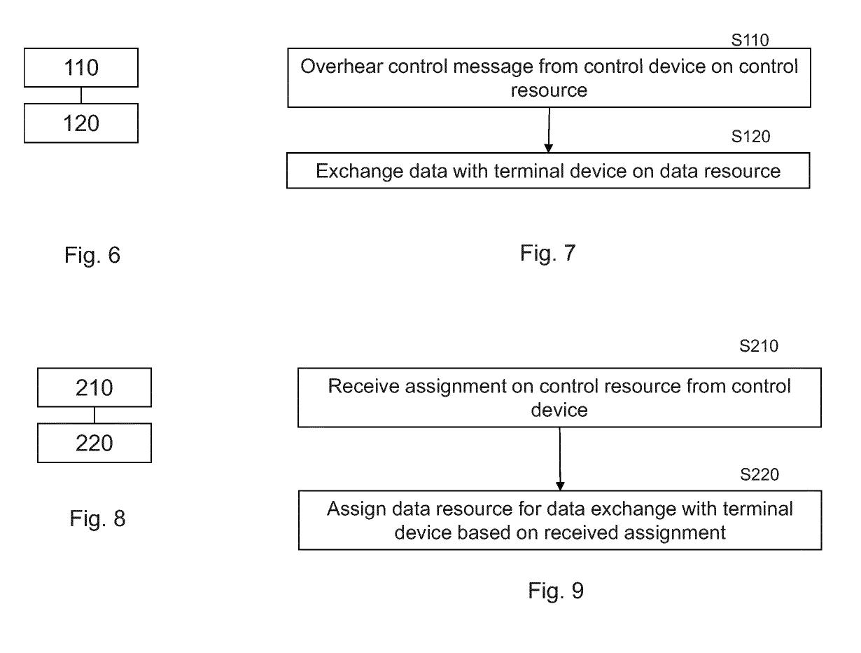

FIG. 6 shows an apparatus according to an embodiment of the invention. The apparatus may be a transceiver device such as a base station, a BTS, a NodeB, an eNodeB, a RRH, or an element thereof. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises overhearing means 110, and data exchanging means 120.

The overhearing means 110 overhears one or more control messages on a control resource from a control transceiver device (S110). The overhearing may comprise at least one of demodulating and decoding. The one or more control messages may comprise a scheduling of a grant for a tereminal device.

The data exchanging means 120 exchanges data with a terminal device such as a UE using a data resource (S120). The data may be related to the user plane. The terminal device is different from the control transceiver device and different from the apparatus.

The data exchanging by the data exchanging means 120 is based on the one or more control messages overheard by the overhearing means 110.

FIG. 8 shows an apparatus according to an embodiment of the invention. The apparatus may be a transceiver device such as a base station, a BTS, a NodeB, an eNodeB, a RRH, or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises data assignment receiving means 210, and assigning means 220.

The assignment receiving means 210 receives, on a control resource, one or more assigning messages from a control transceiver device such as a macro BTS, a NodeB, and an eNodeB (S210).

The assigning means 220 assigns a portion of a data resource to the exchanging of data with a terminal device based on the received one or more assigning messages (S220). The terminal device is different from the control transceiver device and may be e.g. a UE. The data resource is different from the control resource.

In some embodiments, the apparatus may provide, on the data resource, an information on the assigned portion of the data resource to the terminal device.

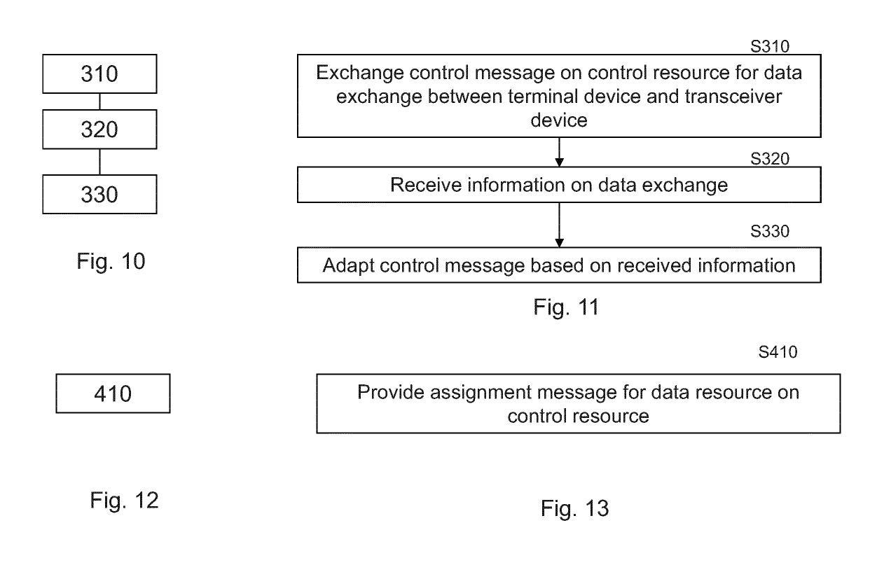

FIG. 10 shows an apparatus according to an embodiment of the invention. The apparatus may be a transceiver device such as a base station, a BTS, a NodeB, an eNodeB, a RRH, or an element thereof. FIG. 11 shows a method according to an embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises control exchanging means 310 and receiving means 320, and adapting means 330.

The control exchanging means 310 exchange one or more control messages with a terminal device using a control resource (S310). Each of the one or more first control messages is not directly related to an exchanging of data between the terminal device and a transceiver device different from the apparatus using a data resource. The data resource used for the data exchange is different from the control resource. The terminal may be e.g. a UE, the transceiver device may be e.g. a BTS, a nodeB, an eNodeB, or a RRH. The transceiver device of the data exchange may be different from the apparatus.

The receiving means 320 receives an information of the exchanging of the data between the terminal device and the transceiver device (S320). The exchanging is based on the one or more control messages.

The adapting means 330 adapts the one or more control messages based on the received information (S330).

FIG. 12 shows an apparatus according to an embodiment of the invention. The apparatus may be a transceiver device such as a base station, a BTS, a NodeB, an eNodeB, a RRH, or an element thereof. FIG. 13 shows a method according to an embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises assignment providing means 410.

The assignment providing means 410 provides, on a control resource, one or more assigning messages to a transceiver device (S410). The transceiver device may be a base station, a BTS, a NodeB, an eNodeB, a RRH etc.. Each of the one or more assigning messages is adapted to assign a portion of a data resource different from the control resource to a data exchange between a terminal device and the transceiver device. The terminal device may be different from the transceiver device.

FIG. 16 shows an apparatus according to an embodiment of the invention. The apparatus comprises a processor 510 and a memory 520. The memory 520 comprises computer program code. The processor 510 and the memory 520 are adapted to cause the apparatus to perform at least one of the methods shown in FIGS. 5, 7, 9, 11, and 13.

In some embodiments, the roles of macro BTS (node (e.g. eNB), host server) and small BTS (node (e.g. eNB), host, server) may be interchanged. That is, in these embodiments, the small cell controls fully or partly the terminal except for its data exchange with the macro cell.

Embodiments of the invention are explained with respect to different frequencies for the control frequency band and the data frequency band, respectively. However, different frequencies are only one way to distinguish different resources used for control by the macro cell (control resource) and data exchange by the small cell (data resource). According to embodiments of the invention, the data resource may be distinguished from the control resource by at least one of a frequency, a timing, and a code. According to some embodiments of the invention, the control resource does not overlap with the data resource in the at least one of the frequency, the timing, and the code.

If the control resource and the data resource are distinguished (inter alia or solely) based on their timings, a meta-resource may comprise several time slots, whereof some time slots are used as control resource and the remaining time slots are used as data resource. Preferably, the time slots of at least one of the meta-resource, the control resource, and the data resource are subsequent.

Embodiments of the invention are explained with respect to a radio interface over which control messages and data are transmitted. However, in some embodiments, on the physical layer, instead of a radio interface, a wired interface may be used.

Instead of in 5G networks, embodiments of the invention may be employed in other radio networks, such as CDMA, EDGE, UMTS, LTE, LTE-A, WiFi networks, etc.. A terminal (device, user device) or a user equipment may be a mobile phone, a smart phone, a PDA, a laptop, multimedia device, tablet, video camera or any other terminal which may be attached to networks of the respective technologies such as LTE, LTE-A or UMTS. A transceiver node may be any cell device such as any base station (BTS) of the respective technology, e.g. a NodeB, an eNodeB, an access point, RRH, etc., irrespective of its coverage area, such as macro cell, pico cell, femto cell. It may be a terminal or user device. In particular, in the present application, NodeB and eNodeB are considered to be equivalent to each other if not otherwise stated or clear from the context.

The provided/received information may comprise one or more pieces of information related to different meanings. One information may be transmitted in one or plural messages.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities (e.g. means) are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on a different software, or some or all of the entities may be based on the same software.

According to the above description, it should thus be apparent that exemplifying embodiments of the present invention provide, for example a base station device such as an eNB, a macro base station device, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that exemplifying embodiments of the present invention provide, for example a base station device such as an eNB, a small base station device, a remote radio head, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplifying embodiments of the present invention provide, for example a terminal device such as a UE, or a component thereof, an apparatus embodying the same, a method for controlling and/or operating the same, and computer program(s) controlling and/or operating the same as well as mediums carrying such computer program(s) and forming computer program product(s).

It should be appreciated that any apparatus according to any embodiment of the invention may include or otherwise be in communication with a control unit, one or more processors or other entities capable of carrying out operations according to any embodiment described e.g. by means of one of the figures. It should be understood that each block of the flowcharts and any combination thereof may be implemented by various means or their combinations, such as hardware, software, firmware, one or more processors and/or circuitry (ASIC (Application Specific IC (Integrated Circuit)) components, FPGA (Field-programmable Gate Arrays) or CPLD (Complex Programmable Logic Device) components or DSP (Digital Signal Processor) components).

It should be understood that the apparatuses may include or be coupled to other units or modules etc., such as radio parts or radio heads, used in or for transmission and/or reception.

Although the apparatuses have been depicted as one entity in some figures, different modules and memory may be implemented in one or more physical or logical entities. Additionally, at least part of the functionalities may be carried out by using cloud services.

An apparatus may in general include at least one processor, controller, module or unit designed for carrying out functions accoding to embodiments described above, operably coupled to at least one memory unit (and to various interfaces). The at least one memory unit may be internal, external or partly internal and partly external. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be, include or be associated with at least one software application, module, unit or entity configured as arithmetic operation, or as a sofware program (including an added or updated software routine), executed by at least one operation processor. Programs, also called program products or computer programs, including software routines, applets and/or macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Computer programs may be coded by a programming language, which may be a high-level programming language, such as objective-C, C, C++, C#, Java, etc., or a low-level programming language, such as a machine language, or an assembler. Modifications and configurations required for implementing functionality of an embodiment may be performed as routines, which may be implemented as added or updated software routines, application circuits (ASIC) and/or programmable circuits. Further, software routines may be downloaded into the apparatus. The apparatus may be configured as a computer or a microprocessor, such as single-chip computer element, or as a chipset, including at least a memory for providing storage capacity used for arithmetic operation and an operation processor for executing the arithmetic operation.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

It should be noted that the description of the embodiments is given by way of example only and that various modifications may be made without departing from the scope of the invention as defined by the appended claims.

1. An apparatus, comprising at least one processor and at least one memory including a computer program code, the at least one memory and the computer program code configured to, with the at least one processor, cause the apparatus at least to:
exchange first data with a data transceiver device using a data resource;
exchange one or more data control messages with the data transceiver device using a control resource different from the data resource, wherein each of the one or more data control messages is directly related to the exchanging of the first data;
exchange one or more first control messages with a control transceiver device different from the data transceiver device using the control resource, wherein each of the one or more first control messages is not directly related to the exchanging of the first data.

2. (canceled)

3. The apparatus according to claim 1, wherein at least one of a frequency, a timing, and a code of the data resource is different from the respective one of a frequency, a timing, and a code of the control resource.

4. The apparatus according to claim 1, wherein the data control messages comprise at least one of an acknowledgment of the exchange of the first data, a non-acknowledgement of the exchange of the first data; a power control command for a transmission power by the terminal device for the exchange of the first data; a demodulation reference symbol for the exchange of the first data; a channel quality indicator of a channel used for the exchange of the first data; a rank selection feedback for the exchange of the first data; and a feedback to signaling related to precoding for the exchange of the first data.

5. The apparatus according to claim 14, wherein the data control messages comprise at least one of an acknowledgment of the exchange of the first data, a non-acknowledgement of the exchange of the first data; a power control command for a transmission power by the terminal device for the exchange of the first data a demodulation reference symbol for the exchanging of the first data; a channel quality indicator of a channel used for the exchange of the first data; a rank selection feedback for the exchange of the first data; and a feedback to signaling related to precoding for the exchange of the first data and wherein the data control messages comprise at least the acknowledgement and the non-acknowledgement.

6. The apparatus according to claim 1, wherein the first control messages comprise at least one of a scheduling of a grant for the exchange of the first data, a power control command for transmission of the terminal device on the control frequency band, and any control message different from each of the data control messages.

7. The apparatus according to claim 1, wherein the first control messages comprise at least one of a scheduling of a grant for the exchange of the first data, a power control command for transmission of the terminal device on the control frequency band, and any control message different from each of the data control messages and wherein the first control messages comprise at least the scheduling of the grant.

8. A user device, comprising an apparatus according to claim 1.

9.-19. (canceled)

20. An apparatus, comprising at least one processor and at least one memory including a computer program code, the at least one memory and the computer program code configured to, with the at least one processor, cause the apparatus at least to:
receive, on a control resource, one or more assigning messages from a control transceiver device; and
assign a portion of a data resource different from the control resource to an exchanging of data with a terminal device different from the control transceiver device based on the received one or more assigning messages.

21. The apparatus according to claim 20, wherein the at least one processor and the at least one memory are adapted to cause the apparatus to:
provide, on the data resource, an information on the assigned portion of the data resource to the terminal device.

22. The apparatus according to claim 20 wherein the at least one processor and the at least one memory are adapted to cause the apparatus to:
exchange the data with the terminal device using the assigned portion of the data resource.

23. The apparatus according to claim 20, wherein the one or more assigning messages comprise at least one of:
an information to assign the assigned portion to the terminal device only if the terminal device fulfills a terminal condition; and
an information to assign the assigned portion to the exchanging of the data only if the exchanging of the data fulfills an exchanging condition;
wherein the at least one processor and the at least one memory are adapted to cause the apparatus to:
prevent the assigning of the portion of the data resource if at least one of the terminal condition and the exchanging condition is not fulfilled.

24. (canceled)

25. The apparatus according to claim 20, wherein at least one of a frequency, a timing, and a code of the data resource is different from the respective one of a frequency, a timing, and a code of the control resource.

26.-35. (canceled)

36. An apparatus, comprising at least one processor and at least one memory including a computer program code, the at least one memory and the computer program code configured to, with the at least one processor, cause the apparatus at least to:
provide, on a control resource, one or more assigning messages to a transceiver device, wherein each of the one or more assigning messages is adapted to assign a portion of a data resource different from the control resource to a data exchange between a terminal device and the transceiver device.

37. The apparatus according to claim 36, wherein at least one of a frequency, a timing, and a code of the data resource is different from the respective one of a frequency, a timing, and a code of the control resource.

38. The apparatus according to claim 36, wherein the data resource and the control resource belong to a same meta resource, and the at least one processor and the at least one memory are adapted to cause the apparatus to:
allocate a first portion of the meta resource to the data resource and a second portion of the meta resource to the control resource, wherein the first portion does not overlap the second portion;
inform the transceiver device and the terminal device on the allocating of at least one of the first portion and the second portion.

39. A base station, comprising an apparatus according to claim 36.

40. A method, comprising:
exchanging first data with a data transceiver device using a data resource;
exchanging one or more data control messages with the data transceiver device using a control resource different from the data resource, wherein each of the one or more data control messages is directly related to the exchanging of the first data;
exchanging one or more first control messages with a control transceiver device different from the data transceiver device using the control resource, wherein each of the one or more first control messages is not directly related to the exchanging of the first data.

41. (canceled)

42. A method, comprising:
receiving, on a control resource, one or more assigning messages from a control transceiver device; and
assigning a portion of a data resource different from the control resource to the exchanging of data with a terminal device different from the control transceiver device based on the received one or more assigning messages.

43. (canceled)

44. A method, comprising:
providing, on a control resource, one or more assigning messages to a transceiver device, wherein each of the one or more assigning messages is adapted to assign a portion of a data resource different from the control resource to a data exchange between a terminal device and the transceiver device.

45.-46. (canceled)
